(19) United States
(12) Patent Application Publication
(10) Pub. No.: US 2024/0288408 A1
(43) Pub. Date: Aug. 29, 2024

(54) ADJUSTING SEPARATION METHOD FOR OTHER SAMPLE SEPARATION DEVICE USING SAMPLE PROPERTIES AND NUMERICAL ANALYSIS

(71) Applicant: Agilent Technologies, Inc., Santa Clara, CA (US)

(72) Inventors: Lena Höninger, Karlsruhe (DE); Uwe Effelsberg, Karlsruhe (DE); Gerhart Metzler, Stutensee (DE)

(21) Appl. No.: 18/284,491

(22) PCT Filed: Mar. 30, 2021
(86) PCT No.: PCT/IB2021/052643

§ 371 Date: Sep. 27, 2023

(51) Int. Cl. G01N 30/86; G01N 30/02

(52) U.S. Cl. CPC G01N 30/8658; G01N 30/8693; G01N 2030/027

(57) ABSTRACT

A device for determining a target separation method for separating a fluidic sample by a target sample separation apparatus modifies an initial separation method for an initial sample separation apparatus. The device includes a data provision unit configured for providing a first initial data set characterizing the initial separation method, a second initial data set characterizing properties of the target sample separation apparatus, a third initial data set characterizing properties of the fluidic sample, a fourth initial data set characterizing properties of the initial sample separation apparatus, and a determining unit configured for determining a target data set characterizing the target separation method by carrying out a numerical analysis based on the first initial data set, the second initial data set, the third initial data set, and the fourth initial data set.

### RELATED APPLICATIONS

This application is the national stage under 35 U.S.C. 371 of International Application No. PCT/IB2021/052643, filed on Mar. 30, 2021, the entire contents of which are incorporated by reference herein.

### TECHNICAL FIELD

The present invention relates to a process of and a device for determining a target separation method for separating a fluidic sample by a target sample separation apparatus by modifying an initial separation method for an initial sample separation apparatus, a process of determining a sample property data set characterizing properties of a prototype fluidic sample, a program element and a computer readable medium.

### BACKGROUND

In liquid chromatography, a fluidic analyte may be pumped through a column comprising a material which is capable of separating different components of the fluidic analyte. Such a material, so-called beads, may be filled into a column tube which may be connected to other elements (like a control unit, containers including sample and/or buffers). Upstream of a column, the fluidic sample or analyte is loaded into the liquid chromatography apparatus. A controller controls an amount of fluid to be pumped through the liquid chromatography apparatus, including controlling a composition and time-dependency of a solvent interacting with the fluidic analyte. Such a solvent may be a mixture of different constituents. The supply of these constituents for subsequent mixing is an example of an operation to be designed by an operator of a liquid chromatography device.

However, developing a separation method for separating a fluidic sample by a sample separation apparatus may be cumbersome.

### SUMMARY

It is an object of the present disclosure to enable the transfer of a separation method from one sample separation apparatus to another in a quick, simple, reliable and user-friendly way.

According to an exemplary embodiment, a process of determining a target separation method for separating a fluidic sample by a target sample separation apparatus by modifying an initial separation method for an initial sample separation apparatus is provided, wherein the process comprises providing a first initial data set characterizing the initial separation method, a second initial data set characterizing properties of the target sample separation apparatus, and a third initial data set characterizing properties of the fluidic sample, and determining a target data set characterizing the target separation method by carrying out a numerical analysis based on the first initial data set, the second initial data set, and the third initial data set.

According to another exemplary embodiment, a device for determining a target separation method for separating a fluidic sample by a target sample separation apparatus by modifying an initial separation method for an initial sample separation apparatus is provided, wherein the device comprises a data provision unit configured for providing a first initial data set characterizing the initial separation method, a second initial data set characterizing properties of the target sample separation apparatus, and a third initial data set characterizing properties of the fluidic sample, and a determining unit configured for determining a target data set characterizing the target separation method by carrying out a numerical analysis based on the first initial data set, the second initial data set, and the third initial data set.

According to still another exemplary embodiment, a process of determining a sample property data set characterizing properties of a prototype fluidic sample, comprising at least part of (for example all or a representative subset of) the components of an adaptation fluidic sample for experimental execution of separation methods on a sample separation apparatus, is provided, wherein the process comprises providing a separation method data set, comprising a plurality of data subsets, characterizing separation methods for the sample separation apparatus, providing an apparatus data set characterizing properties of the sample separation apparatus, and determining the sample property data set characterizing properties of the prototype fluidic sample, by carrying out a numerical analysis based on the apparatus data set and on the separation method data set.

According to still another exemplary embodiment of the present disclosure, a program element (for instance a software routine, in source code or in executable code) is provided, which, when being executed by one or more processors (such as a microprocessor or a CPU) or a part thereof, is adapted to control or carry out a process having the above-mentioned features.

According to yet another exemplary embodiment of the present disclosure, a computer-readable medium (for instance a CD, a DVD, a USB stick, a floppy disk or a hard disk) is provided, in which a computer program is stored which, when being executed by one or more processors (such as a microprocessor or a CPU) or a part thereof, is adapted to control or carry out a process having the above-mentioned features.

Data processing which may be performed according to embodiments of the present disclosure can be realized by a computer program, that is by software, or by using one or more special electronic optimization circuits, that is in hardware, or in hybrid form, that is by means of software components and hardware components.

In the context of the present application, the term “sample separation apparatus” may particularly denote any apparatus which involves the transport, analysis or processing of fluids for separation of a fluidic sample. A fluid may denote a liquid, a gas or a combination of a liquid and a gas, and may optionally also include solid particles, for instance forming a gel or an emulsion. Such a fluid may comprise a mobile phase (such as a fluidic solvent or solvent composition) and/or a fluidic sample under analysis. Examples for sample separation apparatuses are chemical analysis devices, life science apparatuses or any other biochemical analysis systems such as a separation apparatus for separating different components of a sample, particularly a liquid chromatography apparatus, a gas chromatography apparatus, or a supercritical fluid chromatography apparatus. For example, the sample separation can be done by chromatography or electrophoresis.

In the context of the present application, the term “initial sample separation apparatus” may particularly denote a sample separation apparatus for which an initial separation method for separating a fluidic sample has already been developed and is thus existent, and preferably validated. Correspondingly, the term “target sample separation apparatus” may particularly denote another sample separation apparatus for which a target separation method is to be developed for separating the fluidic sample. Initial and target sample separation apparatus may be physically different sample separation apparatuses, in particular differing concerning at least one hardware component, type and/or physical property. For instance, the target sample separation apparatus may have another pump and/or may have another injector and/or may have another sample separation unit than the initial sample separation apparatus.

In the context of the present application, the term “separation method” may particularly denote an instruction for a sample separation apparatus as to how to separate a certain fluidic sample, which is to be carried out by the sample separation apparatus in order to fulfill a separation task associated with the separation method. Such a separation method can be defined by a set of parameter values (for example temperature, pressure, characteristics of a solvent composition, change of solvent composition over time, for instance in terms of a gradient profile for a gradient mode, etc.) and hardware components of the sample separation apparatus (for example the type of separation column used) and an algorithm with processes that are executed when the separation method is executed. A corresponding set of technical parameters for operating the sample separation apparatus during sample separation of a certain fluidic sample may be pre-known, for instance stored in a database or memory accessible by a control unit controlling operation of the sample separation apparatus. Physical properties or operation parameters characterizing a separation method may involve a transport characteristic which may include parameters such as volumes, dimensions, values of physical parameters such as pressure or temperature, and/or physical effects such as a model of friction occurring in a fluidic conduit which friction effects may be modeled, for example, according to the Hagen Poiseuille law. More particularly, the parameterization may consider dimensions of a sample separation apparatus (for instance a dimension of a fluidic channel), a volume of a fluid conduit (such as a dead volume) of the sample separation apparatus, a pump performance (such as the pump power and/or pump capacity) of the sample separation apparatus, a delay parameter (such as a delay time after switching on a sample separation apparatus) of operating the sample separation apparatus, a friction parameter (for instance characterizing friction between a wall of a fluidic conduit and a fluid flowing through the conduit) of operating the sample separation apparatus, a flush performance (particularly properties related to rinsing or flushing the sample separation apparatus before operating it or between two subsequent operations) of the sample separation apparatus, and/or a cooperation of different components of the sample separation apparatus (for instance the properties of a gradient applied to a chromatographic column).

In the context of the present application, the term “initial separation method” for an initial sample separation apparatus may particularly denote a separation method developed specifically for the initial sample separation apparatus for separating a specific fluidic sample. The initial separation method may be used as a starting point for determining a modified separation method having specifically adapted properties for making it appropriate for another sample separation apparatus. For instance, the initial separation method may be a pre-known or pre-developed method.

In the context of the present application, the term “target separation method” for a target sample separation apparatus may particularly denote a separation method developed by modifying an initial separation method for specifically adapting the characteristics (for instance performance, throughput, separation accuracy, etc.) of sample separation of a fluidic sample for execution on the target sample separation apparatus, rather than on the initial sample separation apparatus.

In the context of the present application, the term “modifying a separation method” may particularly denote changing a value of at least one method parameter (in particular changing a value of a plurality of method parameters) and/or changing at least one command to be carried out during execution of the separation method. Additionally or alternatively, modifying a method may encompass adding or removing one or more method parameters and/or commands.

In the context of the present application, the term “fluidic sample” may particularly denote a medium containing the matter which is actually analyzed (for example a biological sample, such as a protein solution, a pharmaceutical sample, etc.).

In the context of the present application, the term “data set” may particularly denote a plurality of parameters with specific values (for instance a temperature value, a percentage of a solvent of a solvent composition, etc.), a specific selection (for instance use of a chromatography column having a length of 80 mm), at least one logic value (for instance “yes” or “no” of a condition, “on” or “off” of a command or hardware component) and/or at least one other attribute. For instance, a data set may be indicative of a specific parameterization.

In the context of the present application, the term “first initial data set characterizing an initial separation method” may particularly denote a number of parameter values and commands (or instructions) characterizing the initial separation method. In particular, the first initial data set may be a complete parameterization of the initial separation method and may include all information and instructions for carrying out the initial separation method. Corresponding operation parameters can include in particular a physical separation condition (such as pressure and/or temperature, for instance at a sample separation unit such as a chromatographic column, a wavelength of a detector, integration parameters, etc.).

In the context of the present application, the term “second initial data set characterizing properties of a target sample separation apparatus” may particularly denote a number of parameter values and hardware attributes characterizing the target sample separation apparatus. In particular, the second initial data set may be a complete parameterization of the target sample separation apparatus and may include all attributes defining the target sample separation apparatus. Corresponding hardware parameters can include in particular an indication which fluid drive unit, which injector, which sample separation unit, and which detector may be implemented in the target sample separation apparatus. Hence, the second initial data set may characterize a used target sample separation apparatus (including a type of sample separation apparatus, for instance chromatographic or electrophoretic, a sample separation apparatus model, etc.).

In the context of the present application, the term “third initial data set characterizing a fluidic sample” may particularly denote at least one property, attribute and/or behavior of the fluidic sample to be separated by the respective sample separation apparatus (i.e. by the initial sample separation apparatus and by the target sample separation apparatus, respectively). For example, a sample parameter forming part of the third initial data set may be an analyte (i.e. a fraction or a species of the fluidic sample to be separated) of the fluidic sample, a plurality of different analytes of the fluidic sample, a concentration of an analyte, a solvent of the fluidic sample, and/or how a fluidic sample reacts on real experimental conditions, such as pressure, temperature or solvent composition. For instance, the third initial data set characterizing a fluidic sample can be determined once for a fluidic sample, for instance for a fluidic sample which has still unknown properties. After having determined the third initial data set for a fluidic sample once, the third initial data set can be used for any future modification of a separation method being related to this fluidic sample. For instance, the third initial data set may then be stored in a database and may be simply accessed when carrying out the process or when using the device for a method transfer. In particular, the third initial data set may comprise information characterizing a behavior of the fluidic sample during separation in the initial sample separation apparatus, and/or information characterizing an interaction of the fluidic sample with a sample separation unit of the initial sample separation apparatus, and/or information characterizing a temperature behavior of the fluidic sample in the initial sample separation apparatus, and/or information characterizing properties of an analyte, in particular of different analytes, of the fluidic sample. Hence, the third initial data set may include information being indicative of an interaction between the fluidic sample and a sample separation apparatus, in particular the initial sample separation apparatus.

In the context of the present application, the term “providing a data set” may particularly denote determining (for instance by measuring) at least part of a data set (in particular of an existing data set), and/or creating at least part of a data set (in particular of a new data set) and/or retrieving (for instance from a database) at least part of a data set (in particular of an existing data set). Determining a data set may comprise experimentally measuring or detecting, theoretically and/or empirically modeling, and/or theoretically calculating a data set. During providing, the data set may be partially created as a completely new data set, and/or an already existing data set may be accessed, for instance from a database.

In the context of the present application, the term “numerical analysis” may particularly denote algorithmic methods that use numerical approximation and/or algorithms for problems of mathematical analysis. A goal of numerical analysis when applied to separation method development is the design and analysis of techniques to give approximate but accurate solutions to hard problems relating to the development of a separation method. Numerical analysis may create, analyze and/or implement algorithms for obtaining numerical solutions to method development related problems involving continuous variables.

According to an exemplary embodiment of the present disclosure, an adaptation of an existing initial separation method for separating a fluidic sample developed for an initial sample separation apparatus may be carried out for execution by another target sample separation apparatus for fulfilling a corresponding sample separation task. Unlike conventional approaches, an exemplary embodiment of the present disclosure uses as a starting point for the separation method conversion between different sample separation apparatuses at least three different initial data sets: A first initial data set is defined for describing the initial separation method, and a second initial data set is defined for describing the target sample separation apparatus. Highly advantageously, a third initial data set is also defined or derived which is indicative of properties of the fluidic sample to be separated, and which may be indicative of an interaction of the fluidic sample with a sample separation apparatus. In form of the third initial data set, absolute analyte properties of the fluidic sample may be taken into account for the separation method adaptation from one sample separation apparatus to another one.

According to an exemplary embodiment of the present disclosure, absolute analyte properties may be properties, which may be completely independent from the actual used sample separation apparatus. Hence, the physical process of separation may be understood solely by taking the absolute analyte properties and the actual physical conditions during the separation into account. In the ideal case, different specific sample separation apparatuses yield the same measurement results, if, for example, the sample and the actual physical conditions during the separation are identical. However, not all components of the sample separation apparatus may be modeled as having no impact on the absolute analyte parameters. For example, the material of the stationary phase of the separation columns may probably have impact on the absolute analyte parameters, and should therefore be of the same type, when using the corresponding absolute analyte parameters for simulations and method transfers or adaptations.

On the basis of the three mentioned initial data sets, a target data set indicating the target separation method to be executed on the target sample separation apparatus may then be determined by carrying out a numerical analysis (e.g., including a finite element analysis) considering each of the first initial data set, the second initial data set, and the third initial data set. Highly advantageously, the described separation method transfer architecture may save time to be spent by a user for method development and for occupying sample separation apparatuses with experiments in terms of method development. Beyond this, fluidic sample material used for the method transfer may be significantly reduced. Moreover, the described method transfer architecture can be easily automated and may be carried out without requiring specific skills of a user. For instance, an exemplary embodiment of the present disclosure can calculate an optimum in an experimental space (that may be not identical with an experimental point, but interpolated). Thus, an excellent quality of the transferred separation method may be achieved.

According to an exemplary embodiment of the present disclosure, a sample property data set (which may also be denoted as intermediate data set, since it may be used as a basis for further calculations) characterizing a prototype fluidic sample may be determined on the basis of a separation method data set being indicative of separation methods, and on the basis of an apparatus data set being indicative of attributes of a sample separation apparatus. By a numerical analysis on the basis of the mentioned data sets, attributes of the prototype fluidic sample may be determined with high accuracy.

Next, further exemplary embodiments of the process, the device, the program element and the computer readable medium will be explained.

An exemplary embodiment of the present disclosure may combine two independent stages of the process: the first stage is a stage for the determination of the fluid sample properties, and the second stage is a stage for the determination of the target separation method. One embodiment only considers the first stage. Another embodiment only considers the second stage. A further embodiment considers the first stage in combination with the second stage. The execution of the second stage may be decoupled by a data base from the execution of the first stage. The first process stage may determine the absolute analyte properties of the fluidic sample in the form of an intermediate data set, also denoted as sample property data set. The obtained result, namely the intermediate data set, may then be stored in a data base. This may be understood as a preparative process stage. When it comes to the execution of the second process stage for the determination of the target method, the data base may provide the third initial data set upon look-up by the second process stage at an arbitrary point in time. Then, the second process stage may determine the target separation method using the determined absolute analyte properties of the fluidic sample in the form of the third data set, recalling it from the data base. The second stage may be arbitrarily executed multiple times, using the third data set, recalled from the data base. The fluidic sample under consideration for the first stage may have the role of a prototype sample for the whole process. It may be chosen to be identical to the fluidic sample under consideration for the method transfer in the second stage. In particular, the prototype fluidic sample for the first process stage may also contain additional analyte components, but in an example, none of the components in the fluidic sample used for the second process stage may be missing, except for the case, its properties have been already determined and stored to the data base, or components are not representative for the second stage. The sample for the second process stage may have the role of a specific adaptation sample, which specifically determines the results of the second process stage.

Now reference is made to the first process stage, which accomplishes the determination of absolute analyte parameters. Starting from the initial sample separation method for the initial sample separation apparatus, a separation method data set (which may also be denoted as fifth data set), comprising a plurality of separation methods for the initial sample separation apparatus, can be provided. This set of separation methods may be provided, for example, by an operator. Each of the separation methods may be related to the initial sample separation method by variation of at least one parameter in such a way, that the separation of the fluidic sample may still be accomplished successfully upon an experimental execution of that separation method on the initial sample separation apparatus. On the other hand, the varied separation method may be arranged in such a way, that this separation method is expected to yield noticeable different experimental chromatograms, revealing the dependency of the fluidic analyte components upon the experimental conditions of the given varied separation method, in comparison to the other experimental chromatograms, obtained from execution of the other varied separation methods and also the initial separation method. The number of separation methods in the fifth data set, the kind of the changed parameters, and the amount of individual parameter changes are subject to the specific sensitivity of the sample analytes under consideration on the experimental conditions, for example composition gradient value range, composition gradient slope, temperature of the separation device, etc.

Still referring to the first process stage, and providing a fifth data set characterizing a plurality of separation methods for the initial sample separation apparatus, as well as the prototype fluidic sample for the first process stage, the process may include the experimental execution of all separation methods of the fifth set of sample separation methods for the initial sample separation apparatus, using the prototype sample. In addition, to determine absolute sample parameters, all methods of the fifth data set are also subject to a simulation of the initial sample separation apparatus, thereby using educated estimations as trial values for the analyte parameters on the first iteration. For instance, such a simulation may use a finite element method or may be based on a phenomenological approach (for instance determining a simulation result by a forward calculation). As a result of the simulation, a simulated chromatogram may be obtained, for instance. The simulation results (for instance the simulated chromatogram) and measurement results (for instance the measured chromatograms) obtained by carrying out the experimental sample separations on the initial sample separation apparatus using the fifth data set, comprising a plurality of separation methods, may then be fitted pairwise in order to obtain absolute chromatographic parameters of the fluidic sample. Referring to the current simulation stage of the process, the absolute analyte parameters can be determined by treating these parameters as variables which can be iteratively changed. More specifically, the change of the absolute analyte parameters may be carried out repeatedly, with subsequent simulations, until sufficiently similar (in particular fulfilling at least one predefined criterion) or identical results are obtained when comparing the simulated and measured results. Each analyte of the fluidic prototype sample to be separated may be represented by a corresponding separate record entry in an intermediate data set, characterizing the properties of the prototype sample, in particular indicating how such an analyte or an entire fluidic sample interacts with a chromatographic separation column, which temperature behavior the analyte or the entire fluidic sample shows, etc. The first process stage may be finished after storing the intermediate data set to the data base.

A gist of an exemplary embodiment of the second process stage is to use, as a starting point for the adaptation of an existing initial separation method-which has been developed for an initial sample separation apparatus for separating a certain fluidic sample (which is namely the adaptation fluid sample)—for another target sample separation apparatus, a first initial data set representing a parameterization of the initial separation method. The target sample separation apparatus can be defined by a second initial data set. A third initial data set, characterizing the specific fluidic sample properties, where the fluidic sample is the specific adaptation sample, may be recalled from the data base. Furthermore, the adaptation of the initial separation method for the target sample separation apparatus (for instance another device type than the initial sample separation apparatus) may include carrying out an experimental sample separation on the initial sample separation apparatus in advance, using the initial separation method and the specific adaptation sample. The obtained measurement result (for instance a chromatogram) may serve as a reference for the subsequent adaptation stage. In the context of such a method adaptation, modification or transfer, the initial separation method may first be simulated on the target sample separation apparatus to obtain real parameters, i.e. data indicating a real behavior of the target sample separation apparatus when executing the initial separation method. For instance, such a simulation may use a finite element method or may be based on a phenomenological approach (for instance determining a simulation result by a forward calculation). As a result of the simulation, a simulated chromatogram may be obtained, for instance. Moreover, each analyte of the fluidic sample to be separated may be defined in a corresponding third initial data set, in particular indicating how such an analyte or an entire fluidic sample interacts with a chromatographic separation column, which temperature behavior the analyte or the entire fluidic sample shows, etc. The above-mentioned simulation results (for instance the simulated chromatogram) and measurement results (for instance a measured chromatogram) obtained by carrying out an experimental sample separation on the initial sample separation apparatus using the initial separation method may then be fitted in order to obtain the target separation method. In this adaptation stage, the target separation method can be determined by treating the method parameters of the initial separation method as a variable trial data set which can be iteratively changed, subsequently followed by a new simulation cycle, as described above. In other words, the trial data set, representing the target separation method, together with the second initial data set, characterizing the properties of the target separation apparatus and the third initial data set, characterizing the specific adaptation sample properties, may be submitted to a new numerical simulation. Each change of the trial data set gives rise for a new simulation cycle. The change of the trial method parameters may be carried out until sufficiently similar (in particular fulfilling at least one predefined criterion) or identical results are obtained when comparing the results of the simulation and the measurement, obtained from executing the initial separation method on the initial separation apparatus. During this iterative change of the method parameters, the properties of the target sample separation apparatus may be taken into account, i.e. the second initial data set, in order to obtain simulation results mimicking also the non-ideal behavior of the target sample separation apparatus. Descriptively speaking, the method parameters may be changed in such a way that for the device parameters of the target sample separation apparatus the results from executing the initial separation method on the initial sample separation apparatus are obtained or at least nearly obtained.

In an embodiment of the process and the device, the determining comprises varying, in particular iteratively varying, the target data set in comparison with the first initial data set until a simulated result of executing the target separation method, characterized by the varied target data set, on the target sample separation apparatus (in particular characterized by the second initial data set) for separating the fluidic sample (in particular characterized by the third initial data set) matches (in particular provides a best match) with an experimental result of executing the initial separation method (in particular characterized by the first initial data set) on the initial sample separation apparatus. For instance, the respective result may be a chromatogram. It is however also possible that the result is a retention time, a delay volume, or any other parameter indicating the outcome of the separation process. Thus, the method adaptation onto another sample separation apparatus may include a repetition, once or multiple times, of the modification of the method parameters to obtain a proper match between the results of executing the initial separation method on the initial sample separation apparatus and the target separation method on the target sample separation apparatus. For instance, the determination process may be continued until chromatograms obtained as a result of a chromatographic sample separation on both sample separation apparatuses upon execution of the initial method and simulation of the respective trial separation method match.

In an embodiment, the device controls and the process comprises simulating execution of the fifth data set (also denoted as separation method data set) of a plurality of initial separation methods on the initial sample separation apparatus, also experimentally executing the same fifth data set of initial separation methods on the initial sample separation apparatus, and determining the intermediate data set, characterizing the prototype fluidic sample properties, based on a comparison and analysis of results of the simulated executions and the experimental executions. Thus, the properties of the prototype fluidic sample may be estimated by comparing the outcome of the simulations and the experimental executions of the fifth data set of a plurality of initial separation methods on the initial sample separation apparatus.

In an embodiment, the device controls and the process comprises simulating execution of the initial separation method on the initial sample separation apparatus based on a fourth initial data set characterizing properties of the initial sample separation apparatus. The fourth initial data set may characterize the initial sample separation apparatus in a similar or corresponding way as the second initial data set characterizes the target sample separation apparatus (as described above). In particular, the simulation may reflect individual particularities of the initial sample separation apparatus, such as dead volume, a characteristic delay which the system requires for reflecting changes in a solvent composition, etc. By the simulation using the fourth initial data set, the actual or real behavior of the initial sample separation apparatus may be taken into account. Due to the individual particularities of the initial sample separation apparatus, the initial sample separation apparatus may behave, in practice or reality, differently from a target behavior as defined by a target separation method. One or more device-specific properties of a sample separation apparatus may be properties which are individual for a very specific sample separation apparatus due to its device-specific artifacts, device-specific operating conditions or other individual characteristics. For example, such device-specific properties may be a delay volume of mobile phase, which delay volume must flow through the sample separation apparatus until an adjustable solvent composition is actually achieved. Also an actual mixing behavior (which may deviate from a desired target behavior) of a proportioning valve for mixing several components of a mobile phase may be such a device-specific property. Also an intrinsic inaccuracy of a composition of a mobile phase due to the intrinsic properties of an individual sample separation apparatus can be such a device-specific property. Furthermore, a leakage behavior of a sample separation apparatus may be such a device-specific property which can be taken into account according to an embodiment of the present disclosure.

In an embodiment, the device controls and the process comprises comparing the results of simulation and experiment by fitting the result of the simulated execution to the result of the experimental execution using properties of the prototype fluidic sample (corresponding to the intermediate data set, which may also be denoted as sample property data set or third initial data set) as fitting parameters. For instance, such a fit may be carried out to find a best match between the simulated and the experimental results. For example, a best match may be assumed when the sum of the least square variations between simulated and experimental results becomes minimum. Fitting parameters may be parameters which may be varied or adjusted during fitting for retrieving the best match. Highly advantageously, the prototype fluidic sample properties may be such fitting parameters. Hence, the fluidic sample properties may be varied until a best match between simulated and experimentally executed separation method is obtained. As a result, absolute analyte properties may be obtained, and may be used as the above-mentioned intermediate data set characterizing properties of the prototype fluidic sample.

In an embodiment of the process and the device, simulating execution comprises considering differences between an ideal behavior and a real behavior of the initial sample separation apparatus when executing the initial separation method. Due to the above-mentioned particularities of a specific initial sample separation apparatus, a theoretically developed ideal method will show deviations when being executed on a real initial sample separation apparatus. Reasons for such deviations are for example a dead volume, a delay time, a leakage, etc. of the real initial sample separation apparatus. For example, a theoretically predefined solvent gradient (as applied during execution of a gradient run on a chromatographic sample separation apparatus) indicating a time-dependence of a specific solvent of a solvent composition may be characterized by a horizontal baseline portion followed by a straight linear increase portion, which is followed, in turn, by a further horizontal portion at a final solvent contribution. A real solvent gradient may show for example a delayed increase and/or rounded sections between the mentioned horizontal sections and the straight section.

In an embodiment of the process and the device, comparing the results comprises comparing a simulated chromatogram resulting from the simulated execution with an experimental chromatogram resulting from the experimental execution. Hence, when the sample separation apparatuses are chromatographic sample separation apparatuses (in particular HPLCs), simulated and experimental chromatograms may be fitted.

In another embodiment, the device controls and the process comprises experimentally executing the fifth data set of a plurality of separation methods on the initial sample separation apparatus, detecting sensor data during experimentally executing the separation methods on the initial sample separation apparatus, and determining the intermediate data set based on a comparison of results of the experimental execution, the detecting of sensor data, and performing simulations. Thus, referring to an above-described embodiment, a theoretical simulation of the results of a sample separation process executed on the initial sample separation apparatus by the separation methods may be performed using the sensing of data instead of taking the fourth initial data set into account (in yet another embodiment, both of these measures may be taken). Descriptively speaking, a discrepancy between an ideal behavior and a real behavior of the initial sample separation apparatus when executing the initial separation method due to particularities of the initial sample separation apparatus and under the influence of the separation of a fluidic sample may also be estimated by sensing sensor data during experimentally executing the initial separation method on the initial sample separation apparatus. Highly advantageously, sensor data sensed on the initial sample separation apparatus during executing the initial separation method may be considered in this numerical analysis-based determination of the absolute analyte parameters of the prototype sample, thus eliminating the need for the initial fourth data set, which may simply not exist for certain initial sample separation apparatuses.

In an embodiment, the device controls and the process comprises comparing the results (of simulation and experiment, and optional of sensor data) by carrying out a numerical analysis. For instance, the numerical analysis may be based on a finite element analysis or any of the numerical analysis tools described below.

In an embodiment of the process and the device, determining the target data set comprises simulating execution of the initial separation method on the target sample separation apparatus. By taking this measure, it may be determined which result the initial separation method delivers when executed on the target sample separation apparatus. A discrepancy between the results of executing the initial separation method on the initial sample separation apparatus and on the target sample separation apparatus may be indicative of differences between those sample separation apparatuses. In the event of such a discrepancy, the target data set may then be modified in comparison with the first initial data set to reduce such a discrepancy. When the discrepancy becomes minimum or falls below a predetermined threshold value, the finally obtained target data set can be accepted for the target sample separation apparatus. Modifiable method parameters may for increments be flow rates, solvent composition, etc.

In an embodiment of the process and the device, simulating execution of the initial separation method on the target sample separation apparatus comprises considering differences between an ideal behavior and a real behavior of the target sample separation apparatus when executing the initial separation method. Thus, during the process of determining the target data set being indicative of the target separation method to be finally executed on the target sample separation apparatus for separating the adaptation fluidic sample, a discrepancy of the real target sample separation apparatus as compared with an ideal behavior may be considered. As described above for the initial sample separation apparatus, such a discrepancy may be related to a dead volume, a delay time and/or shape artefacts in a gradient profile, etc.

In an embodiment of the process and the device, determining the target data set comprises analyzing a result of the simulated execution of the initial separation method on the target sample separation apparatus together with the third initial data set. Highly advantageously, the determination of the target data set for the target sample separation apparatus may be based on a combined assessment of, on the one hand, a simulated real behavior of the target sample separation apparatus when executing the initial separation method to be modified (or an already modified separation method), and, on the other hand, the provided or determined properties of the fluidic sample (in particular absolute analyte parameters). Thus, not only the real behavior of the target sample separation apparatus when executing the separation method to be transferred, but also the real properties of the fluidic sample to be separated may be considered for the method transfer. This ensures that the modified separation method reflects both real device as well as real sample attributes or particularities.

In an embodiment of the process and the device, the analyzing comprises carrying out various numerical analysis. For instance, also the numerical analysis may be based on a finite element analysis or any of the numerical analysis tools described below.

In an embodiment of the process and the device, determining the target data set comprises determining a simulated chromatogram based on a result of the analyzing. When the initial and the target sample separation apparatuses are chromatographic sample separation apparatuses, results to be compared in terms of the method transfer may be chromatograms. In such a chromatogram, one or more characteristic parameters may be analyzed or compared, such as the retention time(s) or retention volume(s) of one or more analytes of the fluidic sample.

In an embodiment, the device controls and the process comprises, once or a plurality of times, iteratively repeating at least one of the simulating execution, analyzing a result of the simulated execution, and determining a simulated chromatogram. The mentioned sequence of processes may be repeated once or a plurality of times until a match (in particular a best match) between, on the one hand, a chromatogram obtained by simulating execution of the target separation method using the (repeatedly modified) target data set on the target sample separation apparatus, and, on the other hand, another chromatogram obtained by experimentally executing the initial separation method using the first initial data set on the initial sample separation apparatus, is found.

In an embodiment, the device controls and the process comprises comparing the determined simulated chromatogram with an experimental chromatogram obtained by experimentally executing the initial separation method on the initial sample separation apparatus. When the simulated chromatogram characterizing the behavior of the (repeatedly modified) target separation method when separating the adaptation fluidic sample on the target separation apparatus partially or entirely corresponds to the experimental chromatogram obtained by experimentally carrying out the initial separation method for separating the adaptation fluidic sample on the initial sample separation apparatus, the method transfer has been successfully completed.

In an embodiment, the device controls and the process comprises iteratively repeating variation of method parameters according to the target data set until the determined simulated chromatogram matches the experimental chromatogram. In particular, the iteration may be repeated until a difference between the determined simulated chromatogram and the experimental chromatogram meets at least one predefined quality criterion, in particular is below a predefined threshold value and/or provides a best match. Descriptively speaking, the initial separation method (characterized by the first initial data set) may be used as a starting point for determining the target separation method (characterized by the target data set), wherein the method parameters (in particular the values of the target data set) are iteratively changed for taking into account a different behavior of the target sample separation apparatus compared with the initial sample separation apparatus.

In an embodiment, the device controls and the process comprises carrying out any of the above mentioned numerical analysis using at least one of the group consisting of a finite element method (FEM) analysis, a finite volume method (FVM) analysis, a finite difference method (FDM) analysis, a boundary element method (BEM) analysis, a control volume method (CVM) analysis, and a random walk method analysis.

A finite element method (FEM) may be desirable. In particular, a finite element method (FEM) can be implemented as a particular numerical method for solving partial differential equations in one, two or three space variables (i.e. the three-dimensional physical space or for simplification of problems in lower dimensional sub-spaces). To solve a problem, the FEM may subdivide a large system into smaller, simpler parts that are called finite elements. This may be achieved by a particular space discretization in the space dimensions, which may be implemented by the construction of a mesh of the object, i.e. the numerical domain for the solution which has a finite number of points. The finite element method formulation of a boundary value problem may finally result in a system of algebraic equations. The method may approximate the unknown function over the domain. The simple equations that model these finite elements may then be assembled into a larger system of equations that models the entire problem. For instance, a finite element method applied to a sample separation apparatus may spatially fractionize a sample separation unit (such as a chromatographic separation column) into a large plurality of volume elements. For each volume element, the behavior may be calculated during execution of a separation method. By taking this measure, the behavior of the entire system, i.e. of the entire sample separation unit may be simulated. Correspondingly, a mobile phase pump, a sample injector, etc. of a sample separation apparatus may be subject of a corresponding finite element analysis as well.

Additionally or alternatively, a finite difference method (FDM) may be carried out which performs discretizations used for solving differential equations by approximating them with difference equations that finite differences approximate the derivatives. FDM may convert a linear ordinary differential equations or non-linear partial differential equations into a system of equations that can be solved by matrix algebra techniques.

Additionally or alternatively, a boundary element method (BEM) may be carried out which may be a numerical computational method of solving linear partial differential equations which have been formulated as integral equations. The integral equation may be regarded as an exact solution of the governing partial differential equation. The boundary element method attempts to use the given boundary conditions to fit boundary values into the integral equation, rather than values throughout the space defined by a partial differential equation. Once this is done, in a post-processing stage, the integral equation can then be used again to calculate numerically the solution directly at any desired point in the interior of the solution domain.

Additionally or alternatively, in a control volume method (CVM), a complete region may be subdivided into control volumes. Nodes may be located at the center of the control volumes. A statement of a conservation equation may be used to form difference equation, or the differential form of the conservation equation may be integrated over the control volume to form difference equation.

Additionally or alternatively, a random walk method may be carried out which may be considered as a mathematical object that describes a path that consists of a succession of random steps on a mathematical space, such as integers.

Particularly desirable may be the finite element analysis. However, also one or more of the other mentioned and/or further numerical analysis methods may be advantageously implemented, additionally or alternatively.

In an embodiment, the process comprises determining the initial separation method by receiving a target specification from a user being indicative of a target of a sample separation task, searching for the initial separation method in a method database, which includes a plurality of reference separation methods, and selecting the initial separation method from the reference separation methods based on the received target specification. In an embodiment, this selection may be made in accordance with a best match with the received target specification. In other words, the reference method showing the best match with the user-defined target specification may be selected as the initial separation method. According to such an embodiment, a reliable, fast and resource-saving system for machine-assisted determination of a meaningful initial separation method may be provided. A user who wants to perform a certain sample separation task (for example, separation and quantitative characterization of two substances of an orange juice sample) can enter the desired separation task or the desired separation target in the form of a user-defined target specification to the method development system. This target specification can then be compared with an archive of many available historical separation methods in order to select an initial separation method from the method database, which, in view of the user-defined target specification, can be seen as a promising starting point for the modified separation method to be developed.

In an embodiment, the process comprises carrying out a gradient run according to the initial separation method on the initial sample separation apparatus. During a gradient run, a solvent composition of mobile phase pumped through a separation path of the sample separation apparatus may be continuously varied. This variation may trigger a desorption-subsequently and individually for different sample fractions—of the fluidic sample which has been previously adsorbed at a sample separation unit such as a chromatographic column.

In embodiments, the determining comprises varying, in particular iteratively varying, the sample property data set, starting from an initial guess as explained above, until a simulated result of executing at least part of (for example all of) the separation methods, characterized by the data subsets contained in the separation method data set, on the sample separation apparatus, characterized by the apparatus data set, for separating the prototype fluidic sample, matches with at least part of (for example all) experimental results of executing the separation methods, characterized by data subsets contained in the separation method data set, on the sample separation apparatus.

In an embodiment, the process comprises simulating execution of at least part of (for example all) separation methods, characterized by data subsets contained in the separation method data set, on the sample separation apparatus, experimentally executing at least part of (for example all) separation methods of the separation method data set, characterized by data subsets contained in the separation method data set, on the sample separation apparatus, determining the sample property data set based on a comparison of results of the simulated execution and the experimental execution, and storing the sample property data set in a database.

In an embodiment, the process comprises simulating execution of the separation methods on the sample separation apparatus based on the apparatus data set characterizing properties of the sample separation apparatus.

In an embodiment, the process comprises comparing the results by fitting the result of the simulated execution to the result of the experimental execution using properties of the prototype fluidic sample as fitting parameters.

In an embodiment, simulating execution comprises considering differences between an ideal behavior and a real behavior of the sample separation apparatus when executing the separation methods.

In an embodiment, the process comprises comparing a simulated chromatogram resulting from the simulated execution with an experimental chromatogram resulting from an experimental execution of the separation methods on the sample separation apparatus.

In an embodiment, the process comprises comparing results from the simulated execution with results from the experimental execution of the separation methods on the sample separation apparatus by carrying out a numerical analysis.

In an embodiment, the sample property data set comprises information characterizing a behavior of the prototype fluidic sample during separation in the sample separation apparatus, information characterizing an interaction of the prototype fluidic sample with a sample separation unit, information characterizing a temperature behavior of the prototype fluidic sample, and/or information characterizing properties of an analyte, in particular of different analytes, of the prototype fluidic sample.

In an embodiment, the process comprises determining an actual composition of a mobile phase present at a sample separation unit of at least one of the initial sample separation apparatus and the target sample separation apparatus, in particular experimentally and/or by simulation. An actual composition of such a mobile phase (in particular a solvent composition) at a chromatographic separation column or the like may be different from a target composition of the mobile phase, as defined by a target sample separation method. In order to obtain additional information concerning the actual or real mobile phase composition, experimental measurements may be carried out, for instance using sensor data. Additionally or alternatively, information with respect to the actual or real solvent composition may also be derived theoretically by simulation. Hence, the solvent composition actually applied to the column may be determined, in particular by measuring and/or by simulation. The determination of the actual solvent composition (compared to the desired solvent composition prescribed by the method) establishes a paradigm shift as compared with the conventional principle: “What you set is what you get”. Correspondingly, a method transfer may be carried out in a more meaningful way.

Embodiments may be implemented in conventionally available HPLC systems, such as the analytical Agilent 1290 Infinity II LC system or the Agilent 1290 Infinity II Preparative LC/MSD system (both provided by the applicant Agilent Technologies-see www.agilent.com).

One embodiment of a sample separation apparatus comprises a pump having a pump piston for reciprocation in a pump working chamber to compress liquid in the pump working chamber to a high pressure at which compressibility of the liquid becomes noticeable. This pump may be configured to know (by means of operator's input, notification from another module of the instrument or similar) or elsewise derive solvent properties.

The sample separation unit of the sample separation apparatus may comprise a chromatographic column (see for instance en.wikipedia.org/wiki/Column_chromatography) providing a stationary phase. The column may be a glass or steel tube (for instance with a diameter from 50 μm to 5 mm or with a diameter from 1 mm to 10 mm, for example up to a diameter of 20 mm, and a length of 1 cm to 1 m) or a microfluidic column (as disclosed for instance in EP 1577012 or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, surface modified silica gel, followed by alumina. Cellulose powder has often been used in the past. Also possible are ion exchange chromatography (IEX), reversed-phase chromatography (RP), normal-phase chromatography (NP), affinity chromatography (AC), hydrophilic interaction chromatography (HILIC) or expanded bed adsorption (EBA). The stationary phases are usually finely ground powders or gels and/or are microporous for an increased surface.

The mobile phase (or eluent) can be a pure solvent or a mixture of different solvents (such as water and an organic solvent such as ACN, acetonitrile). It can be chosen for instance to adjust the retention of the compounds of interest and/or the amount of mobile phase to run the chromatography. The mobile phase can also be chosen so that the different compounds or fractions of the fluidic sample can be separated efficiently. The mobile phase may comprise an organic solvent like for instance methanol or acetonitrile, often diluted with water. For gradient operation water and organic solvent are delivered in separate bottles, from which the gradient pump delivers a programmed blend to the system. Other commonly used solvents may be isopropanol, tetrahydrofuran (THF), hexane, ethanol and/or any combination thereof or any combination of these with aforementioned solvents.

The fluidic sample may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 15-150 MPa (150 to 1500 bar), and more particularly 50-120 MPa (500 to 1200 bar).

The sample separation apparatus, for instance an HPLC system, may further comprise a detector for detecting separated compounds of the fluidic sample, a fractionating unit for outputting separated compounds of the fluidic sample, or any combination thereof.

In various embodiments, a sample as described herein may be processed in a liquid sample separation apparatus (e.g., HPLC apparatus) to obtain data as part of one or more of the methods described herein, and at least part of the obtained data may be utilized in one or more of such methods.

Embodiments of the present disclosure can be partly or entirely embodied or supported by one or more suitable software programs or products (or software), which may be stored on or otherwise provided by any kind of non-transitory medium or data carrier, and which might be executed in or by any suitable data processing unit such as an electronic processor-based computing device (or system controller, control unit, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform the steps of the method of any of the embodiments disclosed herein.

### BRIEF DESCRIPTION OF DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 shows two liquid sample separation apparatuses, particularly used in high performance liquid chromatography (HPLC), and a method transfer device in accordance with embodiments of the present disclosure.

FIG. 2 shows a device for determining a target separation method for separating a fluidic sample by a target sample separation apparatus by modifying an initial separation method for an initial sample separation apparatus according to an exemplary embodiment.

FIG. 3 shows a scheme illustrating a process of determining absolute analyte properties of a prototype fluidic sample composition by a sample separation apparatus, of which the absolute analyte properties are suited for determining modified separation methods for other sample separation apparatuses in a separate subsequent process, according to an exemplary embodiment.

FIG. 4 shows a scheme illustrating a process of determining a target separation method for separating an adaptation fluidic sample by a target sample separation apparatus by modifying an initial separation method for an initial sample separation apparatus according to an exemplary embodiment.

FIG. 5 shows another scheme illustrating the whole process, comprising the process stages of FIG. 3 and FIG. 4 of determining a target separation method for separating an adaptation fluidic sample by a target sample separation apparatus by modifying an initial separation method for an initial sample separation apparatus according to an exemplary embodiment.

The illustrations in the drawings are schematic.

### DETAILED DESCRIPTION

Before describing the figures in further detail, some basic considerations of the present disclosure will be summarized based on which exemplary embodiments have been developed.

Conventionally, development of a separation method for a sample separation apparatus is time consuming and is done with a large number of experiments, with different method parameters and an orthogonal set of chromatographic methods. The experimental results are evaluated according to certain criteria. The best separation method is chosen.

However, the large number of conventionally necessary experiments are time consuming. Furthermore, a large amount of sample material is needed which is used or even consumed during such experiments. A gained result of the described conventional approach is not the optimum, but just the best result in a limited experimental matrix.

According to an exemplary embodiment of the present disclosure, a system of transferring a separation method for separating a specific fluidic sample from an initial sample separation apparatus to a target sample separation apparatus is provided. As a starting point, the initial separation method with its known first initial data set is used. As a further starting point, a parameterization of the target sample separation apparatus in form of a second initial data set may be used. Highly advantageously, properties of an adaptation fluidic sample to be separated on the respective sample separation apparatus may also be considered as a further basis for the method transfer. The properties of the adaptation fluidic sample may be reflected in a third initial data set. For example, the properties of a specific fluidic sample may be determined once, and may then be reused for various method transfer purposes relating to the fluidic sample. The properties of the fluidic sample may include data relating to a single analyte of the fluidic sample or may relate to multiple different analytes of the fluidic sample to be separated. For instance, the parameters indicating the properties of the fluidic sample may comprise intrinsic sample properties (such as identity and/or concentration of an analyte, number and amounts of different analytes, solvent in which the one or more analytes is present) and/or extrinsic sample properties in relation to a sample separation apparatus (such as a behavior of the fluidic sample on a respective sample separation apparatus, at a specific temperature, in a specific mobile phase, etc.). The mentioned initial data sets may then be processed for determining a target separation method for execution for separating the adaptation fluidic sample on another target sample separation apparatus, so that the result of the sample separation on the target sample separation apparatus when carrying out the modified target separation method equals or is sufficiently similar to a result of the sample separation on the initial sample separation apparatus when carrying out the initial separation method. To achieve such a compliance, the method transfer process may include a (in particular iteratively repeated) modification of the initial data set relating to the initial separation method so that the modified separation method when executed on the target sample separation apparatus behaves like the initial sample separation apparatus when separating the fluidic sample using the initial separation method.

More specifically, an exemplary embodiment of the present disclosure enables a separation method transfer (in particular for an HPLC) using a numerical analysis such as a finite element simulation. In a first processing stage, an exemplary embodiment may use information from a simulation of a real behavior of the execution of a separation method on a sample separation apparatus to gain absolute gradient data. With a numerical analysis, for instance a finite element analysis, further parameters may be gained (such as a real temperature in a chromatographic separation column during sample separation). The parameters may then be iterated to predict the different chromatograms. As the described process is fast, a large amount of theoretical results can be produced to select the best method in a stochastic or iterative process.

In particular, exemplary embodiments of the present disclosure may at least partially overcome at least part of the following and/or other conventional issues: The described method transfer architecture may save time, may reduce the amount of fluidic sample needed for method transfer, and/or may reduce the required work labor. A process according to an exemplary embodiment of the present disclosure can be automated and can be performed even by less experienced users. During execution of such a process, it may be possible to calculate the optimum in the experimental space that is not identical with an experimental point but interpolated.

In an embodiment, a prototype fluid sample running on a given HPLC system may be processed for determining absolute sample parameters. Experimental executions together with simulations with different separation method parameters may result in chromatograms which can be evaluated concerning the sample analyte's behavior requiring only a small or even a minimal necessary amount of experimental testing. Hence, the method conversion architecture according to an exemplary embodiment of the present disclosure may simulate the results, for instance by considering a real rather than ideal behavior of a sample separation apparatus during execution of a separation method.

A goal of an exemplary embodiment of the present disclosure is to develop a new or modified separation method for a target sample separation apparatus based on a starting point, i.e. an initial separation method for an initial sample separation apparatus. While an exemplary embodiment of the present disclosure may use a given target chromatogram, the initial separation method may then be tweaked to best match with such a target chromatogram.

An exemplary embodiment of the present disclosure simulates execution of an initial separation method on an initial sample separation apparatus for determining a real behavior of the method on the apparatus. The results of such a simulation may hence be used to gain information concerning the real behavior of the method on the apparatus, for instance to obtain absolute gradient data in a gradient mode. With a numerical analysis (for instance a finite element method), further parameters may be gained (for example a real temperature in a sample separation unit, such as a chromatographic separation column). In a subsequent process, it may be possible to extract molecular chromatographic parameters of the fluidic sample, more specifically of the sample components. This may be accomplished by carrying out a numerical analysis (for instance a finite element method). Thereafter, the method parameters may be iterated to complete the method transfer between different sample separation apparatuses. This may involve a prediction of different chromatograms, or more generally of the results of the execution of the separation methods on the sample separation apparatuses.

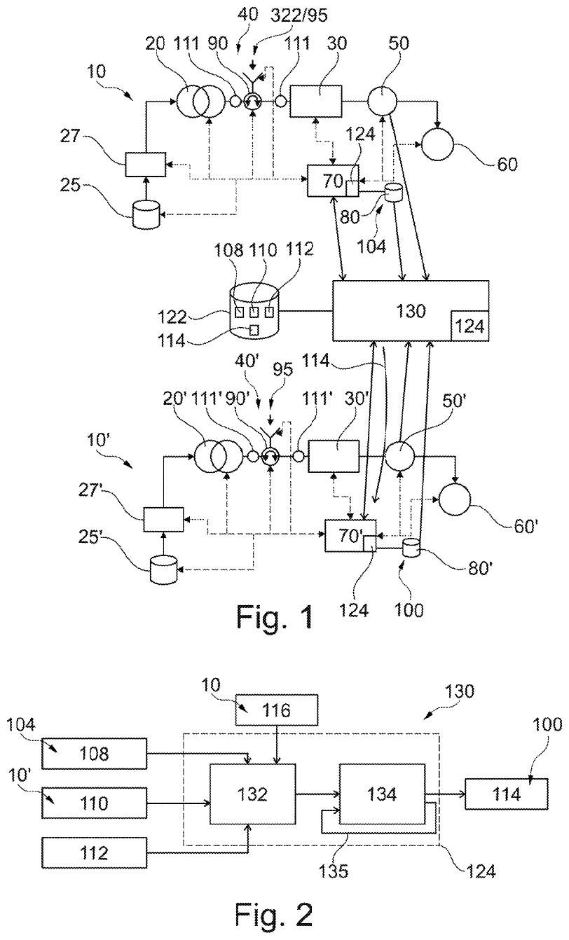

FIG. 1 shows two liquid sample separation apparatuses 10, 10′, particularly used in high performance liquid chromatography (HPLC), and a (connected or unconnected) method transfer device 130 in accordance with embodiments of the present disclosure.

Sample separation apparatus 10 may be denoted as initial sample separation apparatus, since an initial separation method (i.e. a set of parameters and a sequence of commands to be used for executing a specific sample separation task) for separating a specific fluidic sample (which may be a prototype sample 322 as well as an adaptation sample 95) has been developed specifically for sample separation apparatus 10. FIG. 1 relates to the scenario that the user now wants to carry out separation of the adaptation fluidic sample 95 on sample separation apparatus 10′, which may thus be denoted as target sample separation apparatus. Sample separation apparatuses 10, 10′ may differ concerning one or more hardware components, for instance may have different sample separation units 30, 30′, different fluid drive units 20, 20′, different injectors 40, 40′, etc. In the following, construction and operation of initial sample separation apparatus 10 will be described in detail. Construction and operation of target sample separation apparatus 10′ can be accordingly but will not be described in detail for the sake of conciseness, and like parts of sample separation apparatuses 10, 10′ are indicated by a respective reference sign and corresponding reference sign with apostrophe. Thereafter, it will be described how an initial separation method 104 for separating the fluidic sample by the initial sample separation apparatus 10 can be transferred to a target separation method 100 for separating this fluidic sample by target sample separation apparatus 10′.

Referring now in greater detail to the drawings, FIG. 1 depicts a general schematic of initial sample separation apparatus 10. A fluid drive 20 (such as a piston pump) receives a mobile phase from a solvent supply 25 via degassing unit 27, which degases and thus reduces the amount of dissolved gases in the mobile phase. The fluid drive 20 drives the mobile phase through a separation unit 30 (such as a chromatographic column) comprising a stationary phase. A sampler or injector 40, implementing a fluidic valve 90, can be provided between the fluid drive 20 and the separation unit 30 in order to subject or add (often referred to as sample introduction) a sample fluid into the mobile phase so that a fluidic sample and mobile phase may be provided towards a separation path where actual sample separation occurs. Reference sign 322 indicates the prototype sample fluid, whereas the adaptation sample fluid is indicated by reference sign 95. The stationary phase of the separation unit 30 is configured for separating compounds of the sample liquid. A detector 50 is provided for detecting separated compounds of the sample fluid. A fractionating unit 60 can be provided for outputting separated compounds of sample fluid. It is also possible to provide a waste at the position of fractionating unit 60.

While the mobile phase can be comprised of one solvent only, it may also be mixed from plural solvents. Such mixing may be a low pressure mixing and provided upstream of the fluid drive 20, so that the fluid drive 20 already receives and pumps the mixed solvents as the mobile phase. Alternatively, the fluid drive 20 may comprise plural individual pumping units, with plural of the pumping units each receiving and pumping a different solvent or mixture, so that the mixing of the mobile phase (as received by the separation unit 30) occurs at high pressure and downstream of the fluid drive 20 (or as part thereof). The composition of the mobile phase may be kept constant over time, the so called isocratic mode, or varied over time, the so called gradient mode. One or more sensors 111 may be arranged along the flow path, for instance one between the fluid drive 20 and injector 40 and another one between injector 40 and sample separation unit 30. Sensor data detected by the sensors 111 may be optionally used for the method transfer and may be supplied to control unit 70.

The data processing unit or control unit 70, which can be a PC or workstation, and which may comprise one or more processors 124, may be coupled (as indicated by dashed arrows) to one or more of the devices in the sample separation apparatus 10 in order to receive information and/or control operation and/or for carrying out method transfer processing. For method transfer processing, one or more further processors 124 may be provided in device 130. For example, the control unit 70 may control operation of the fluid drive 20 (for example setting control parameters) and receive therefrom information regarding the actual working conditions (such as output pressure, etc. at an outlet of the pump. e.g., fluid drive 20). Optionally, the control unit 70 may also control operation of the solvent supply 25 (for example setting the solvent/s or solvent mixture to be supplied) and/or the degassing unit 27 (for example setting control parameters and/or transmitting control commands) and may receive therefrom information regarding the actual working conditions (such as solvent composition supplied over time, vacuum level, etc.). The control unit 70 may further control operation of the sampling unit or injector 40 (for example controlling sample injection or synchronization of sample injection with operating conditions of the fluid drive 20). The separation unit 30 may also be controlled by the control unit 70 (for example selecting a specific flow path or column, setting operation temperature, etc.), and send-in return-information (for example operating conditions) to the control unit 70. Accordingly, the detector 50 may be controlled by the control unit 70 (for example with respect to spectral or wavelength settings, setting time constants, start/stop data acquisition), and send information (for example about the detected sample compounds) to the control unit 70. The control unit 70 may also control operation of the fractionating unit 60 (for example in conjunction with data received from the detector 50) and provides data back.

As already mentioned, for operating target sample separation apparatus 10′ according to FIG. 1 in accordance with a desired separation task (for instance the separation of a specific sample in a specific way), a corresponding target separation method 100 needs to be developed for the target sample separation apparatus 10′ based on the initial separation method 104 being available for the sample separation apparatus 10 for the task of separating the same adaptation fluidic sample 95. Processing tasks for this method transfer may be executed by device 130 and its one or more processors 124, optionally in combination with one or more processors 124 in any of control units 70, 70′. Parameters and commands for carrying out the initial separation method 104 may be stored in a database 80 of initial sample separation apparatus 10. Correspondingly, parameters and commands for carrying out the target separation method 100 may be stored in a database 80′ of target sample separation apparatus 10′.

In the shown embodiment, the method determining device 130 is configured for carrying out a process of determining target separation method 100 for separating an adaptation fluidic sample 95 by the target sample separation apparatus 10′ by modifying the initial separation method 104 which has already been developed for the initial sample separation apparatus 10. The process may comprise providing a first initial data set 108 characterizing the initial separation method 104, a second initial data set 110 characterizing properties of the target sample separation apparatus 10′, a third initial data set 112 characterizing properties of the adaptation fluidic sample 95 to be separated and a fourth initial data set 116 characterizing properties of the initial sample separation apparatus 10. The initial data sets 108, 110, 112, 116 may be stored in a database 122. Device 130 may have read and/or write access to database 122. The device 130 may be configured for determining a target data set 114 characterizing the target separation method 100 by carrying out a numerical analysis based on the first initial data set 108, the second initial data set 110, and the third initial data set 112. As shown, the target data set 114 may be sent to control unit 70′ of target sample separation apparatus 10′ for execution to separate the fluidic sample. Device 130 may also store the target data set 114 in the database 122.

Details concerning the method transfer will be described in the following referring to FIG. 2 to FIG. 5;

FIG. 2 shows a device 130 for determining a target separation method 100 for separating a fluidic sample by a target sample separation apparatus 10′ by modifying an initial separation method 104 for an initial sample separation apparatus 10 according to an exemplary embodiment.

As shown, the device 130 comprises a data provision unit 132 configured for receiving and providing the first initial data set 108 characterizing the initial separation method 104, the second initial data set 110 characterizing properties of the target sample separation apparatus 10′, and the third initial data set 112 characterizing properties of the fluidic sample and its interaction with a sample separation apparatus 10/10′. Moreover, the data provision unit 132 may be configured for receiving and providing additionally a fourth initial data set 116 characterizing properties of the initial sample separation apparatus 10. The data provision unit 132 may receive at least part of the respective data sets 108, 110, 112, 116 for instance from a database (such as database 122 shown in FIG. 1) and/or may determine, detect and/or calculate at least part of the respective data set 108, 110, 112, 116.

Information required for carrying out the method transfer may be forwarded from the data provision unit 132 to a determining unit 134. The latter may be configured for determining the target data set 114 characterizing the target separation method 100. During processing, determining unit 134 may also carry out a numerical analysis (in particular a finite element analysis) and may consider for the processing the first initial data set 108, the second initial data set 110, and the third initial data set 112. The fourth initial data set 116 may for instance be used for simulating execution of the initial separation method 104 on the initial sample separation apparatus 10. For determining the target separation method 100, method parameters according to the first initial data set 108 may be modified for adapting the initial separation method 100 to the characteristics of the target sample separation apparatus 10′. This may include, once or multiple times, an iterative repetition of the processing task carried out by determining unit 134, as indicated by a feedback loop 135 in FIG. 2.

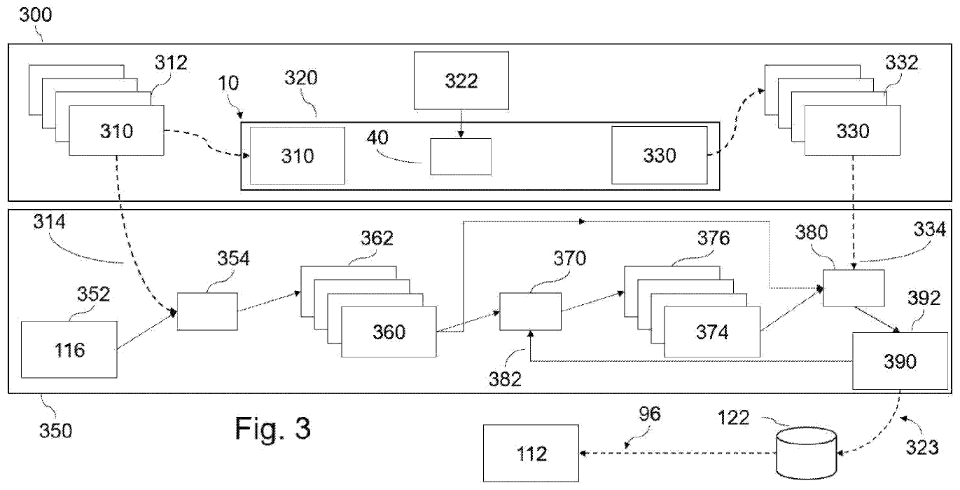

FIG. 3 shows a scheme illustrating a process for the determination of the properties of the prototype fluidic sample 322 to be separated by an initial fifth data set of a plurality of data subsets 310, characterizing separation methods. The fifth data set is shown with reference sign 312 and may also be denoted as separation method data set. This may be understood as a preparative process stage for one or multiple subsequent executions of the method transfer process and needs to be carried out only once for a given prototype fluidic sample 322 (which may be a composition of a plurality of analytes), being representative for adaptation fluidic sample 95 under consideration for the method transfer.

The determination of the properties of the prototype fluidic sample 322 is a two-stage process, indicated by blocks 300 and 350. Block 300 encompasses a plurality of experimental executions of the separation of the provided prototype fluidic sample 322 on the initial sample separation apparatus 10. Block 350 comprises a numerical analysis of the obtained results of block 300. In other words, all experimental executions of block 300 may be carried out first. As soon as all executions are performed and all results of block 300 are obtained, the numerical analysis in block 350 may follow subsequently.

Starting point of the determination of the properties of the prototype fluidic sample 322 according to FIG. 3 is a block indicated with reference sign 312 and relates to the separation method data set or fifth initial data set, comprising a plurality of data subsets 310, being indicative of separation methods suited for separating the prototype fluidic sample 322 on initial sample separation apparatus 10. More specifically, data subsets 310 are separation method data subsets for separating the prototype fluidic sample 322. Depending on specific properties of the prototype fluidic sample 322, the separation method data set 312 of data subsets 310 describing separation methods for the sample separation apparatus 10 comprises different methods for separating the prototype fluidic sample 322. Typically, each method corresponding to a data subset 310 has at least one parameter differing from all other methods in separation method data set 312, for example different composition gradient slopes, -duration, initial-value, flow-setting, or column set-point temperature, etc. Thus, the separation method data set 312 of data subsets 310 may be capable to stimulate specific dependencies of each of the different analytes of the analyte composition in form of prototype fluidic sample 322 upon differing physical and chemical separation conditions, stimulated in a different way by each specific data subset 310. The specific arrangement of the fifth initial data set or separation method data set 312 depends on the specific sample composition of prototype fluidic sample 322. An appropriate parameterization of the separation method data set 312 may then reveal the fluidic sample properties under investigation indirectly in an obtained set 332 of data subsets 330 of experimental chromatograms, each one associated to a specific data subset 310.

The execution of block 300 may comprise consecutive execution of each single data subset 310 in the initial sample separation apparatus 10, indicated by reference sign 320, of which not all parts are shown, referring to FIG. 1. It should be mentioned that each execution separates the same prototype fluidic sample 322, provided by sampling unit or injector 40. The obtained data set 330 of kind of experimental chromatogram may be stored intermediately in set 332, waiting for subsequent further processing in block 350.

Referring to FIG. 3, the next processing stage is the execution of block 350, which describes a numerical analysis. Input data for block 350 is provided by block 300, namely the fifth initial set or separation method data set 312, comprising the plurality of data subsets 310, being indicative of separation methods for the initial sample separation apparatus 10, and a further intermediate set 332 comprising a plurality of data subsets 330, representing experimental chromatograms. Reference sign 314 indicates the provision of data subset 312 from block 300 (experimental) to block 350 (numerical analysis), respectively reference sign 334 for data subset 332.

A further starting point of the process according to FIG. 3 is a block 352 indicating a fourth initial data set 116 being indicative of a construction of the initial sample separation apparatus 10. In other words, the fourth initial data set 116 provides a device data set for characterizing the initial sample separation apparatus 10.

Block 354 relates to a simulation of an execution of a separation method on the initial sample separation apparatus 10 characterized by the fourth initial data set 116. A single data subset 310 and the fourth initial data set 116 may be combined in block 354, in which a simulation of the separation method represented by data subset 310 on the initial sample separation apparatus 10 is carried out. This simulation may take into account the real behavior of the initial sample separation apparatus 10 when executing the separation method represented by data subset 310, wherein the real behavior may be different from an ideal behavior in view of particularities of the initial sample separation apparatus 10 (for instance in view of non-ideal phenomena due to leakage, delay or dead volume). In other words, simulating execution comprises considering differences between an ideal behavior and a real behavior of the initial sample separation apparatus 10 when executing the separation method represented by data subset 310. A result of the simulation in block 354, corresponding to a specific data subset 310, is stored as a data subset 360 in the set 362. When the initial sample separation apparatus 10 is a liquid chromatography device, the result represented in data subset 360 may be a simulated non-ideal, i.e. real, gradient. More generally, the result may also be denoted as a predicted real value of a physical variable of the separation process (e.g. gradient composition). All data subsets 310 of separation method data set 312 are processed in order and independently by block 354, and the results are stored intermediately in data set 362, comprising data subsets 360.

In a block 370, the results obtained in block 354 may be processed together with results from a block 380, see reference sign 382, indicating a feed-back-path from block 380 back to block 370, thereby supplying an intermediate result, namely current result, of a sample property data set 390 (which, in its final form, is to be determined as an aim of the described process) in block 392. The feed-back-path indicates an iterative procedure, feeding results from block 370 first to block 380, then again back to block 370. The data set in the feed-back-path coincides with the current state of the sample property data set 390, representing the absolute analyte properties of the prototype fluid sample 322 to be determined. Before the first cycle, the current fluidic sample property data set 390 is initialized by an educated estimate from block 380. The processing task according to block 370 comprises a simulation of the separation of the initial sample separation apparatus 10. This simulation may be done for instance by a finite element analysis. Descriptively speaking, the simulated real gradients 360 from block 354, and the current fluidic sample property data set 390 are processed together in such a way, that simulated “real” chromatograms in data subsets 374 may be obtained, representing a separation of a fictive fluidic sample, having yet the properties of the current sample property data set 390. Also, other simulated physical variables may be obtained from the simulation, e.g. temperature, pressure, etc., stored along with the chromatogram in data subsets 374. The described processing is done for all simulated real gradients 360 of set 362, using the same current fluidic sample property data set 390. The result of block 370 is a corresponding set 376 of simulated real chromatograms forming subsets 374 and may comprise also other physical variables.

Now referring to block 380, the result set 376 of block 370 is processed together with the intermediate set 332 from block 300, see reference sign 334. Both inputs provide data sets of kind chromatogram. Each data subset 374 of set 376 corresponds to a particular data subset 330 of set 332 by the fact, that the same separation method was used, described by a particular data subset 310. Additionally, the outcome of block 360 is provided with data subsets 360 to the block 380. Thus, the further processing is carried out using associated triplets of corresponding data subsets 360, 374, and 330. More precisely speaking, the processing being carried out in block 380 is mainly a numerical comparative analysis of corresponding pairs of data sets of kind chromatogram, using additional information from the simulated gradient. Advantageous aspects are the order and retention time of the peaks of the components of the prototype fluidic sample 322. Also, various other aspects may be considered. In a second processing stage inside block 380, all results are put together, but this time, the results may be arranged by correspondence to a specific fluidic sample component (or analyte), collected from all input triplets.

As already mentioned, a further input to block 380 is the set 362 of data subsets 360, representing simulated real gradients. When interpreting the chromatograms as being the result in a cause-and-effect-relation, the simulated real gradients, together with other simulated physical variables from data subset 374, e.g. temperature, or other local physical conditions within the column, etc., reveal the physical cause for the generated effect, which is exhibited by the order and retention time of the peaks in the associated chromatograms (simulated as well as experimental). In a third processing stage inside block 380, a further mathematical analysis, considering the multi-parametric dependency of each specific analyte peak being subject to the given set of physical causes in the data subsets 360 and 374, may yield an improved partial contribution to the fluidic sample property trial data set 390. The improved trial data set corresponds to a further processed sample property data set 390 which now gives rise to a new cycle of iteration.

No cyclic iteration stages of the process have been considered so far. According to the numerical analysis in block 380, the comparative analysis may also estimate a measure for the quality of the match of the experimental and simulated chromatograms. Thus, it may be determined whether the current fluidic sample property data set 390 (yet a fictive fluidic sample) is already a valid representation of the parameters of the prototype fluidic sample properties or not. The measure of the match may be fine-tuned by specific weighting parameters, also specific criteria for specific peaks may be applied. The fine-tuning parameters of the match-measure are not explicitly depicted in the figure and will be understood by a person skilled in the art as constant global background parameters for the determination process, which may be predefined by the operator.

Still referring to block 380, and considering the case that the match criteria are not satisfied, a further iteration cycle may run through, and an improvement of the current fluidic sample property data set 390 (still a fictive fluid sample) may be achieved. The execution passes block 370 and again block 380. Descriptively speaking, the peaks of the simulated chromatograms, represented by data sets 374, may be fitted to the peaks of the measured chromatograms, represented by data sets 330, by adjusting the fluidic sample property parameters in sample property data set 390. On the other hand, if the match criteria are satisfied, the cyclic execution may be finished, and the current result sample property data set 390 of block 392 is the result to be determined. Hence, the result of the processing in block 350 may be the absolute analyte parameters of the analyte composition forming the prototype fluidic sample 322, represented by sample property data set 390 in block 392.

It should be mentioned that the process of FIG. 3, as described up to now, relates to the determination of the properties of the prototype fluidic sample 322. By proper choice of the prototype fluidic sample 322, e.g. just taking the adaptation fluid sample composition 95 under consideration, which is to be separated both by the initial separation method 104 and the target separation method 100, the results obtained in the determination process are of direct relevance for the main processing stage for determining the target separation method 100. In the general case, it may also be possible for the prototype fluid sample 322 to have additional components beside the required components of the adaptation sample 95 under consideration. However, the properties of the prototype fluidic sample 322 need to be determined only once, and the associated sample property data set 390 can be stored in a database 122 for further method transfer tasks. In one embodiment, the prototype fluidic sample 322 may be identical to the adaptation fluidic sample 95.

The intermediate fluidic sample parameter data set or sample property data set 390, being representative for the prototype fluidic sample 322, may be stored to the database 122 in such a way, that the analyte specific property parameters of the known separate analytes of the prototype fluidic sample 322 may be discerned (indicated by reference sign 323). The parameters corresponding to a single analyte may be stored in separate records for each analyte, along with a descriptive key describing the common designation of the analyte.

As shown by reference sign 96, the fluidic sample parameter data set 112, corresponding to the components in the adaptation fluidic sample 95, may be looked up and recalled from the database 122 and may be input as third initial data set 112 in the main processing stage for determining the target separation method 100.

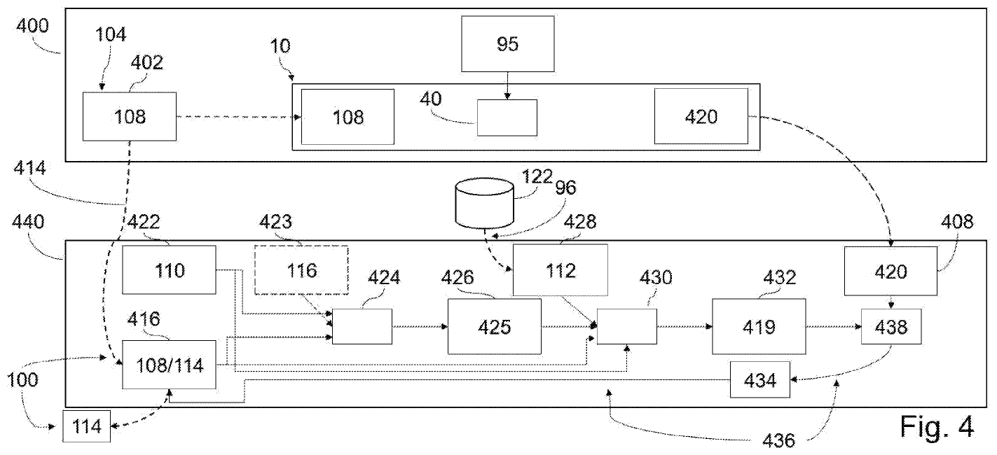

FIG. 4 shows a scheme illustrating a process of determining a target separation method 100 for separating an adaptation fluidic sample 95 by a target sample separation apparatus 10′ by modifying an initial separation method 104 for an initial sample separation apparatus 10 according to an exemplary embodiment. The basis for the method transfer may be the first to fourth initial data sets 108, 110, 112, 116, as described below. It should be emphasized, that this method transfer process specifically aims to transfer the initial method with special consideration of the specific separation results of adaptation fluid sample 95 on the initial sample separation apparatus 10. Thus, the method transfer may be accomplished by specifically adapting the target separation method 100 to the fluid sample 95, namely adaptation fluidic sample.

The starting point of the method transfer procedure according to FIG. 4 is an experimental execution of a separation on the initial sample separation apparatus 10, indicated by block 400. Referring to the separation in block 400, a block 402 indicates a first initial data set 108 being indicative of an initial separation method 104 which is readily developed and validated for separating an adaptation fluidic sample 95 on initial sample separation apparatus 10. More specifically, first initial data set 108 is a separation method data set for an existing method for separating a fluidic sample. The first initial data set 108 may describe the programmed method.

A further starting point for the method transfer procedure may be the provision of the experimental result chromatogram 420, obtained in the above-mentioned experimental execution of the separation of the adaptation fluidic sample 95 on the initial sample separation apparatus 10, using the first initial data set 108. The injection of the fluidic sample 95 to the sampling unit or injector 40 of the initial sample separation apparatus 10 is shown in FIG. 4, as a part of the complete sample separation apparatus 10 shown in FIG. 1. Provision of the experimental result chromatogram 420 means, the experimental execution of the initial separation method 104 was performed and a result chromatogram 420 obtained and stored, such as in database 122, no matter whether in the context of the current method transfer process, or at any point in time before, i.e. not related to this process.

As shown by reference sign 96, a third starting point for the method transfer procedure may be the provision of the third initial data set 112 in a main block 440 for determining the target separation method 100. The a priori known sample composition components (analytes) of adaptation fluid sample 95 may be looked up in the database 122, using the same designation scheme for the analytes as was used upon storage of the intermediate fluidic sample parameter set or sample property data set 390 before, and the corresponding records are read out and collected in the third initial data set 112 characterizing properties of the fluidic sample 95, stored to block 428. The look up and recall is indicated by reference sign 96, compare also to FIG. 3.

Now referring to the main block 440, the initial separation method 104 may be input into a block 416 as an initial guess (see reference sign 414) or starting point for determining target data set 114 representing the target separation method 100 for separating the fluidic sample on target sample separation apparatus 10′.

Now referring to a block 424, the initial guess in form of initial separation method 104 may be processed in combination with a second initial data set 110 (see block 422) which indicates the properties of the target sample separation apparatus 10′, i.e. includes a corresponding device data set. In addition, a fourth initial data set 116 characterizing properties of the initial sample separation apparatus 10 may be provided in block 423. The inputs from blocks 416, 422 and 423, and thus, the initial separation method 104, characterized by data set 108, the current target separation method, characterized by data set 114, the target separation apparatus properties in data set 110, along with the initial separation apparatus properties in data set 116, may be subject to a simulation in block 424. Thus, determining the target data set 114 comprises simulating execution of the initial separation method 104 on the target sample separation apparatus 10′. Descriptively speaking, the simulation may be indicative of a result obtained by carrying out initial separation method 104 on target sample separation apparatus 10′.

More specifically, a simulated real result (for instance, a simulated real gradient) 425 of the execution of the initial separation method 104 on the target sample separation apparatus 10′ may be obtained in block 426, including the impact of a non-ideal behavior of target sample separation apparatus 10′ reflecting its particularities (for instance in terms of leakage behavior, dead volume properties, delay characteristics, etc.). The results obtained in block 426 may also be denoted as a predicted real method on target sample separation apparatus 10′. Hence, simulating execution comprises considering differences between an ideal behavior and a real behavior of the target sample separation apparatus 10′ when executing the initial separation method 104.

Now referring to block 430, the result obtained in block 426 may be processed together with the absolute analyte parameters of the fluidic sample to be separated according to block 428 using third initial data set 112 imported from the database 122. Hence, determining the target data set 114 comprises analyzing a result of the simulated execution in view of or together with the third initial data set 112. More specifically, block 428 may include the third initial data set 112, being characteristic for the fluidic sample to the separated, being obtained from the data base 122 and being transferred into the main block 440 as indicated by reference sign 96. The processing task according to block 430 may be related to a further numerical analysis, for instance a further finite element analysis.

A result of the processing, according to block 432, is a simulated chromatogram 419, i.e. a theoretically obtained chromatogram when executing initial separation method 104 on target sample separation apparatus 10′ for separating the adaptation fluidic sample 95 according to the third initial data set 112.

As indicated by reference sign 434 in a feedback path 436, the described processing between blocks 416 and 432 may then be repeated iteratively, once or multiple times. During this iteration, the method parameters of target data set 114 to be determined may be changed in comparison with the initial first data set 108 being indicative of the initial separation method 104 to determine the target separation method 100. More specifically, the variation of the method parameters may be made so that the simulated chromatogram 419 obtained in block 432 during this iteration becomes most similar or even identical to the experimental chromatogram 420 in block 408. Descriptively speaking, the adjustment of the method parameters for determining the target data set 114 is carried out so that the simulated chromatogram 419 relating to an execution of the target separation method 100 (corresponding to the draft or present target data set 114) on the target sample separation apparatus 10′ matches with the experimental chromatogram 420 obtained when experimentally executing the initial separation method 104 on the initial sample separation apparatus 10. The match of the chromatograms 419, 420 may be analyzed by various criteria, e.g. comparison of retention times, etc., by a numerical processing in block 438.

Still referring to the previously described iteration loop, determining the target data set 114 may comprise a repeated determination of simulated chromatogram 419 based on a result of the described analysis. More specifically, the process comprises, once or a plurality of times, iteratively repeating the simulating execution in block 424, further simulating execution in block 430, and the determining of the simulated chromatogram 419 in block 432. The determined simulated chromatogram 419 may be compared with the experimental chromatogram 420 obtained by experimentally executing the initial separation method 104 on the initial sample separation apparatus 10. The iterative loop may be repeated until a difference between the determined simulated chromatogram 419 and the experimental chromatogram 420 meets at least one predefined quality criterion, for instance is below a predefined threshold value and/or provides a best match (i.e. a better match than all other analyzed alternatives). The target data set 114 providing a match (or meeting a condition according to the previous sentence) can then represent the target separation method 100.

Concluding, the first initial data set 108 characterizing the initial separation method 104 (see blocks 402 and 416), the second initial data set 110 characterizing properties of the target sample separation apparatus 10′ (see block 422), the third initial data set 112 characterizing properties of the fluidic sample (see blocks 122, 428), and the fourth initial data set 116 characterizing properties of the initial sample separation apparatus 10 (see block 423) may be compiled as a basis for the method transfer. On this basis and by carrying out an iterative approach (see reference signs 434, 436), the target data set 114 (see block 416) characterizing the target separation method 100 may be determined by carrying out a numerical analysis based on the first initial data set 108, the second initial data set 110, the third initial data set 112, and the fourth initial data set 116. As described, the determining comprises iteratively varying the target data set 114 starting with the first initial data set 108 until a simulated result (see simulated chromatogram 419) of executing the corresponding target separation method 100 on the target sample separation apparatus 10′ for separating the fluidic sample provides a (for instance best) match with an experimental result (see experimental chromatogram 420) of executing the initial separation method 104 on the initial sample separation apparatus 10 (compare blocks 400, 408).

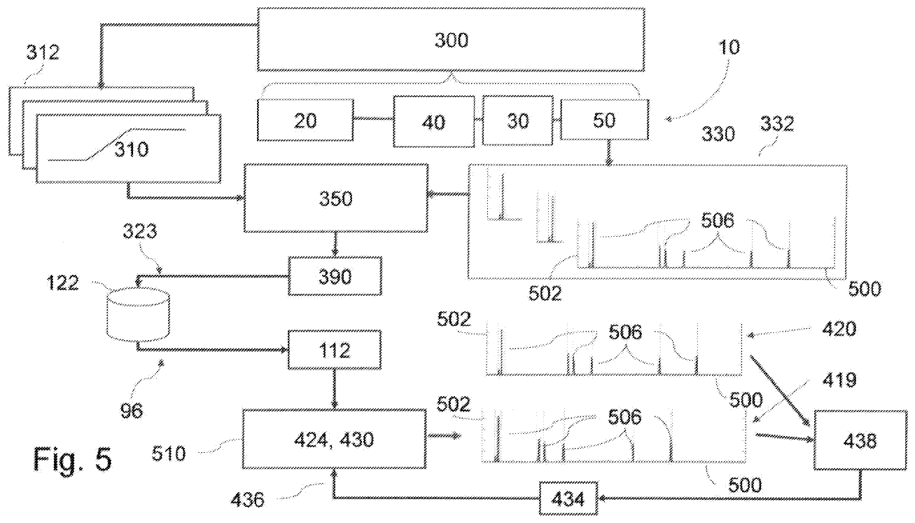

FIG. 5 shows another scheme illustrating a process of determining a target separation method 100 for separating a fluidic sample by a target sample separation apparatus 10′ by modifying an initial separation method 104 for an initial sample separation apparatus 10 according to an exemplary embodiment.

In FIG. 5, referring to FIG. 3 and FIG. 4, blocks 300 and 350 refer to a complete, absolute characterization of the physical properties of a fluidic sample 322 to be separated. In other words, blocks 300 and 350 refer to a determination of an intermediate data set 390 (and therewith, data set 112 is intentionally included) characterizing properties of the prototype fluidic sample 322 (and therewith, adaptation fluid sample 95 is intentionally included) to be separated by the sample separation apparatuses 10, 10′. The determination of the intermediate data set 390 may be based on an evaluation of a known behavior of an initial sample separation apparatus 10 and/or a simulation (for instance an FEM simulation) together with predefined separation method parameters. In this context, in block 300 (referring to FIG. 3), a plurality 332 of experimental chromatograms 330 may be measured by carrying out a plurality 312 of initial separation methods 310 on the illustrated initial sample separation apparatus 10 (concerning constituents 20, 40, 30 and 50 thereof, reference is made to FIG. 1). Along an abscissa 500 of the experimental chromatograms 330, 420 (respectively simulated chromatogram 419), the retention time is plotted.

Along an ordinate 502 of the experimental chromatograms 330, 420 (respectively 419), a detector signal is plotted. Reference signs 506 indicate peaks in the experimental chromatograms 330, 420 (resp. 419), which may correspond to analytes of the fluidic sample 322 for chromatograms 330 (reference to FIGS. 3 and 4 is made, respectively fluid sample 95 for chromatograms 420, 419), to be separated.

In order to determine properties of the fluidic sample and thus for determining the intermediate data set 390, simulated chromatograms (not shown in FIG. 5, but shown with reference sign 374 in FIG. 3) may be fitted to the experimental chromatograms 330. During this fit (for instance a least squares fit), the parameters of the intermediate data set 390 may be the variable fitting parameters. Reference sign 350 (referring to FIG. 3) indicates the fit and a finite element analysis. As a result, the absolute chromatographic parameters of the analytes of the fluidic sample are obtained, i.e. the intermediate fluid sample parameter data set or sample property data set 390.

The intermediate fluid sample parameter data set or sample property data set 390, being representative for prototype fluid sample 322, may be stored to a data base 122 in such a way, that the known fluid sample analytes of the prototype fluidic sample 322 may be discerned (indicated by reference sign 323). The corresponding parameters are stored in separate records for each analyte, along with a descriptive key describing the common designation of the analyte.

When it comes to the determination of a target data set 114, the properties of the known sample composition analytes of adaptation fluid sample 95 can be looked up in the database 122, using the same designation scheme for the analytes as was used upon storage of the intermediate fluid sample parameter set or sample property data set 390 before, and the corresponding records are read out and collected in the third initial data set 112 characterizing properties of the fluidic sample 95, as indicated by reference sign 96.

As indicated again with reference sign 434, the method parameters may then be changed or varied for determining the target separation method 100 based on the initial separation method 104 and taking into account information concerning initial data sets 108, 110, 116, 112 (a reference to FIG. 4 is made). During the variation of the method parameters, it is for instance possible to change a flow rate, a solvent composition, shape and/or parameters of a gradient profile, etc. By a numerical analysis and/or another kind of simulation, referring to blocks 424 and 430 of FIG. 4 (see reference sign 510), a simulated chromatogram 419 may be determined which indicates a result to be expected when executing a draft target separation method in accordance with the presently modified method parameters on the target sample separation apparatus 10′. The modification of the method parameters may continue in an iterative way (see reference sign 436) until a match between the simulated chromatogram 419 and the experimental chromatogram 420 (referring to FIG. 4) is obtained, and the target data set 114 is achieved simultaneously.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller 500 schematically depicted in FIGS. 4 and 5. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller 500 schematically depicted in FIGS. 4 and 5), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

1. A process of determining a sample property data set characterizing properties of a prototype fluidic sample and comprising at least part of components of an adaptation fluidic sample for experimental execution of separation methods on a sample separation apparatus, the process comprising:
providing a separation method data set, comprising a plurality of data subsets, characterizing separation methods for the sample separation apparatus;
providing an apparatus data set characterizing properties of the sample separation apparatus; and
determining the sample property data set characterizing properties of the prototype fluidic sample, by carrying out a numerical analysis based on the apparatus data set and on the separation method data set.

2. The process according to claim 1, wherein the determining comprises iteratively varying the sample property data set, starting from an initial guess, until a simulated result of executing at least part of the separation methods, characterized by the data subsets contained in the separation method data set, on the sample separation apparatus, characterized by the apparatus data set, for separating the prototype fluidic sample, matches with at least part of experimental results of executing the separation methods, characterized by data subsets contained in the separation method data set, on the sample separation apparatus.

3. The process according to claim 1, comprising:
simulating execution of at least part of separation methods, characterized by data subsets contained in the separation method data set, on the sample separation apparatus;
experimentally executing at least part of separation methods of the separation method data set, characterized by data subsets contained in the separation method data set, on the sample separation apparatus;
determining the sample property data set based on a comparison of results of the simulated execution and the experimental execution; and
storing the sample property data set in a database.

4. The process according to claim 3, comprising at least one of the following features:
wherein the process comprises simulating execution of the separation methods on the sample separation apparatus based on the apparatus data set characterizing properties of the sample separation apparatus;
wherein the process comprises comparing the results by fitting the result of the simulated execution to the result of the experimental execution using properties of the prototype fluidic sample as fitting parameters;
wherein simulating execution comprises considering differences between an ideal behavior and a real behavior of the sample separation apparatus when executing the separation methods;
wherein the process comprises comparing a simulated chromatogram resulting from the simulated execution with an experimental chromatogram resulting from an experimental execution of the separation methods on the sample separation apparatus;
wherein the process comprises comparing results from the simulated execution with results from the experimental execution of the separation methods on the sample separation apparatus by carrying out a numerical analysis.

5. The process according to claim 1, wherein the sample property data set comprises at least one of the following:
information characterizing a behavior of the prototype fluidic sample during separation in the sample separation apparatus;
information characterizing an interaction of the prototype fluidic sample with a sample separation unit;
information characterizing a temperature behavior of the prototype fluidic sample;
information characterizing properties of one or more analytes of the prototype fluidic sample.

6. A process of carrying out a method transfer by determining a target separation method for separating a fluidic sample by a target sample separation apparatus by modifying an initial separation method for an initial sample separation apparatus, the process comprising:
providing a first initial data set characterizing the initial separation method and a second initial data set characterizing properties of the target sample separation apparatus;
executing a data determination operation, wherein the data determination operation comprises a selection of data stored in a database, according to known analytes of a fluidic sample under consideration for the method transfer;
composing the selected data as a third initial data set, characterizing properties of the fluidic sample; and
determining a target data set characterizing the target separation method by carrying out a numerical analysis based on the first initial data set, the second initial data set, and the third initial data set.

7. The process according to claim 6, wherein the determining comprises iteratively varying the target data set in comparison with the first initial data set until a simulated result of executing the target separation method, characterized by the varied target data set, on the target sample separation apparatus, characterized by the second initial data set, for separating the fluidic sample, characterized by the third initial data set, matches with an experimental result of executing the initial separation method, characterized by the first initial data set, on the initial sample separation apparatus.

8. The process according to claim 6, comprising simulating execution of the initial separation method on the initial sample separation apparatus based on a fourth initial data set characterizing properties of the initial sample separation apparatus.

9. The process according to claim 8, comprising at least one of the following features:
wherein simulating execution comprises considering differences between an ideal behavior and a real behavior of the initial sample separation apparatus when executing the initial separation method;
wherein the process comprises comparing a simulated chromatogram resulting from the simulated execution with an experimental chromatogram resulting from an experimental execution of the initial separation method on the initial sample separation apparatus;
wherein the process comprises comparing results from the simulated execution with results from an experimental execution of the initial separation method on the initial sample separation apparatus by carrying out a numerical analysis.

10. The process according to claim 6, wherein determining the target data set comprises simulating execution of the initial separation method on the target sample separation apparatus.

11. The process according to claim 10, wherein the simulating execution comprises considering differences between an ideal behavior and a real behavior of the target sample separation apparatus when executing the initial separation method.

12. The process according to claim 10, wherein determining the target data set comprises analyzing a result of the simulated execution together with the third initial data set.

13. The process according to claim 12, comprising at least one of the following features:
wherein the analyzing comprises carrying out a numerical analysis;
wherein determining the target data set comprises determining a simulated chromatogram based on a result of the analyzing.

14. The process according to claim 10, comprising, once or a plurality of times, iteratively repeating at least one of:
the simulating execution;
analyzing a result of the simulated execution together with the third initial data set;
determining a simulated chromatogram based on a result of the analyzing to determine the target data set.

15. The process according to claim 12, wherein determining the target data set comprises determining a simulated chromatogram based on a result of the analyzing, and the process further comprises at least one of the following:
the process further comprises comparing the determined simulated chromatogram with an experimental chromatogram obtained by experimentally executing the initial separation method on the initial sample separation apparatus;
the process further comprises comparing the determined simulated chromatogram with an experimental chromatogram obtained by experimentally executing the initial separation method on the initial sample separation apparatus, and iteratively repeating until the determined simulated chromatogram matches the experimental chromatogram.

16. The process according to claim 6, wherein the third initial data set comprises at least one of the following:
information characterizing a behavior of the fluidic sample during separation in the initial sample separation apparatus;
information characterizing an interaction of the fluidic sample with a sample separation unit;
information characterizing a temperature behavior of the fluidic sample;
information characterizing properties of an analyte, in particular of different analytes, of the fluidic sample.

17. The process according to claim 6, comprising at least one of the following:
determining an actual composition of a mobile phase present at a sample separation unit of at least one of the initial sample separation apparatus and the target sample separation apparatus;
determining an actual composition of a mobile phase present at a sample separation unit of at least one of the initial sample separation apparatus and the target sample separation apparatus, wherein the determining of the actual composition is done experimentally
determining an actual composition of a mobile phase present at a sample separation unit of at least one of the initial sample separation apparatus and the target sample separation apparatus, wherein the determining of the actual composition is done by simulation.

18. A non-transitory computer-readable medium, comprising instructions stored thereon, that when executed on a processor, control or perform one or more of the steps of claim 1.

19. A non-transitory program element, wherein the program element, when being executed by one or a plurality of processors, is configured to carry out or control one or more of the steps of claim 1.

20. A device for determining a target separation method for separating a fluidic sample by a target sample separation apparatus by modifying an initial separation method for an initial sample separation apparatus, the device comprising:
a data provision unit configured to provide a first initial data set characterizing the initial separation method, a second initial data set characterizing properties of the target sample separation apparatus, a third initial data set characterizing properties of the fluidic sample, and a fourth initial data set characterizing properties of the initial sample separation apparatus; and
a determining unit configured to determine a target data set characterizing the target separation method by carrying out a numerical analysis based on the first initial data set, the second initial data set, the third initial data set, and the fourth initial data set.
